(19) United States
(12) Patent Application Publication
(10) Pub. No.: US 2007/0260573 A1
(43) Pub. Date: Nov. 8, 2007

(54) Multi-values lookups between lists with arbitrary schema

(75) Inventors: Jason F. Morrill, Redmond, WA (US); Andrew Sean Watson, Seattle, WA (US); Hai Liu, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/429,566

(22) Filed: May 5, 2006

(51) Int. Cl. G06F 17/30

(52) U.S. Cl. 707/1

(57) ABSTRACT

Described herein is technology for, among other things, performing multi-value lookups to lists having arbitrary schema. The technology involves the creation of first lists having arbitrary schema based on inputs from clients. The clients then create multi-value lookup (MVL) fields, which lookup to the first lists. Queries are then built based on the MVL fields and transmitted to a backend. The results of the queries are received from the backend and then passed on to the clients.

### BACKGROUND

As the world progresses more and more into the digital age, people are digitizing everything from checkbooks and bills to contact lists and grocery lists. This movement towards digitization of information has opened a door for software companies to create programs that provide a convenient way for people to keep their information and records in digital form. One such type of software is personal list and database software. This software allows users to digitize recipe collections, contact lists, shopping lists, etc. By digitizing this type of information, the information becomes more accessible (e.g., stored on a server accessible by the internet) and easier to search.

Hosting listing and database services on the internet requires a delicate balancing act. Software developers want to provide end-users with high functionality and the ability to create their own schema (the term schema refers to the structure of a list or database), while at the same time maintaining a high degree of scalability in the developers' servers.

Today there are several types of this software. One type does not allow for arbitrary schema. An example of this type is a database that is designed and tailored for a specific purpose, such as corporate billing software. This method is scalable, but obviously does not allow much flexibility from the point of view of the end-user. If an end-user needed a database for an entirely different purpose, the user would have to purchase a separate software package that suits his or her new purposes. Another type of list/database software allows for arbitrary schema, but is unable to perform multi-value lookups to the created lists, thus limiting its utility for some users. Ordinarily, a multi-value lookup would be accomplished with a junction table. However, the currently used and understood methods for creating junction tablese involve a proliferation of tables which a database engine supporting many users has trouble managing. Thus, the current methods do not all for a database system to scale to have many different types of lookups.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, performing multi-value lookups to lists having arbitrary schema. The associated graphical user interfaces (GUIs) and data structures are also disclosed herein. The technology may be implemented via a web page.

The technology involves the creation of lists having arbitrary schema based on inputs from clients. The clients then create multi-value lookup (MVL) fields, which lookup to the lists. Clients may create the MVL fields via a GUI. The GUI involves displaying the titles of the user's lists for selection. One manner of displaying and selecting the titles is by a drop-down list. Once a list has been selected, the items of the selected list are displayed for the user to select as references for the MVL fields. Once the MVL fields are created, queries are then built based on the MVL fields and transmitted to a backend. The results of the queries are received from the backend and then passed on to the clients.

Thus, embodiments provide technology for performing multi-value lookups to lists having arbitrary schema. The techniques and data structures described herein provide for efficient data storage and transmission. Such technology is ideal for a highly scalable server capable of supporting numerous schemas. Because of the efficiency of the technology described herein, it is possible for a server to support a greater number of users than its maximum number of connections.

### BRIEF DESCRIPTION OF THE DRAWINGS

The accompanying drawings, which are incorporated in and form a part of this specification, illustrate embodiments and, together with the description, serve to explain their principles:

FIG. 1 is a block diagram of an exemplary computing system environment for implementing embodiments.

FIG. 2 is a block diagram of a general network-based database system for implementing embodiments.

FIG. 3 is a flowchart of a process for performing multi-valued lookups to lists having arbitrary schema, in accordance with an embodiment.

FIG. 4 is a flowchart of a process for displaying on a display device a plurality of first lists and a second list, in accordance with an embodiment.

FIG. 5 illustrates one example of a display for showing titles of first lists, in accordance with an embodiment.

FIG. 6 illustrates one example of a display for showing the elements of a user-selected list.

FIG. 7 illustrates one example of a display for displaying a second list.

FIG. 8 illustrates a block diagram of a data structure, which is stored on a computer-readable medium; in accordance with an embodiment.

### DETAILED DESCRIPTION

Reference will now be made in detail to the preferred embodiments of the claimed subject matter, examples of which are illustrated in the accompanying drawings. While the invention will be described in conjunction with the preferred embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

Described herein is technology for, among other things, performing multi-value lookups to lists having arbitrary schema. The associated graphical user interfaces (GUIs) and data structures are also disclosed herein. The technology may be implemented via a web page.

The technology involves the creation of lists having arbitrary schema based on inputs from clients. The clients then create multi-value lookup (MVL) fields, which lookup to the lists. Clients may create the MVL fields via a GUI. The GUI involves displaying the titles of the user's lists for selection. One manner of displaying and selecting the titles is by a drop-down list. Once a list has been selected, the items of the selected list are displayed for the user to select as references for the MVL fields. Once the MVL fields are created, queries are then built based on the MVL fields and transmitted to a backend. The results of the queries are received from the backend and then passed on to the clients.

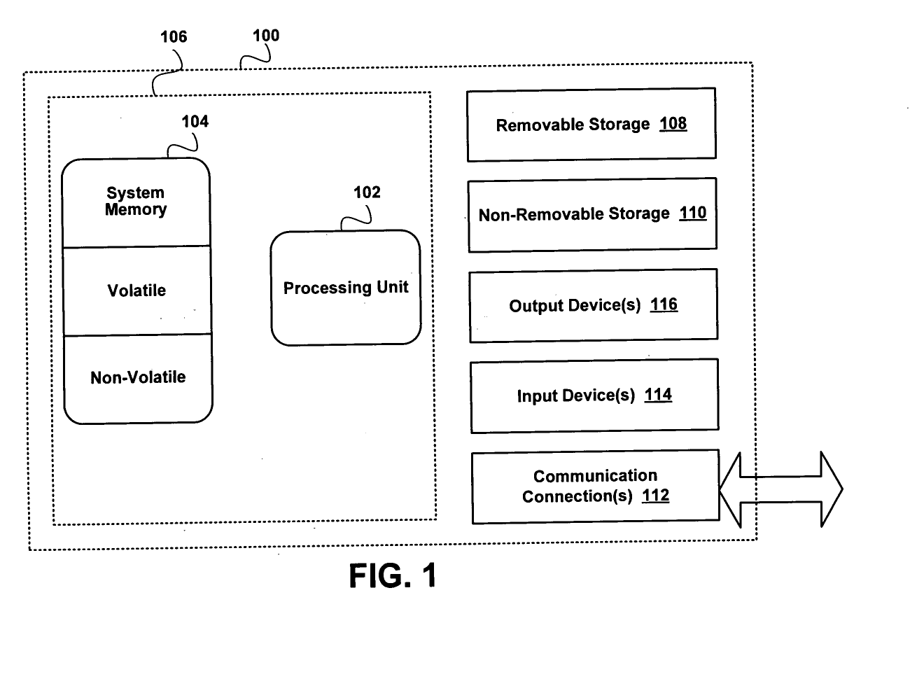

With reference to FIG. 1, an exemplary system for implementing embodiments includes a general purpose computing system environment, such as computing system environment 100. In its most basic configuration, computing system environment 100 typically includes at least one processing unit 102 and memory 104. Depending on the exact configuration and type of computing system environment, memory 104 may be volatile (such as RAM), non-volatile (such as ROM, flash memory, etc.) or some combination of the two. This most basic configuration is illustrated in FIG. 1 by dashed line 105. Additionally, computing system environment 100 may also have additional features/functionality. For example, computing system environment 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and nonremovable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

Computing system environment 100 may also contain communications connection(s) 112 that allow it to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Computing system environment 100 may also have input device(s) 114 such as a keyboard, mouse, pen, voice input device, touch input device, etc. Output device(s) 116 such as a display, speakers, printer, etc. may also be included. All these devices are well known in the art and need not be discussed at length here.

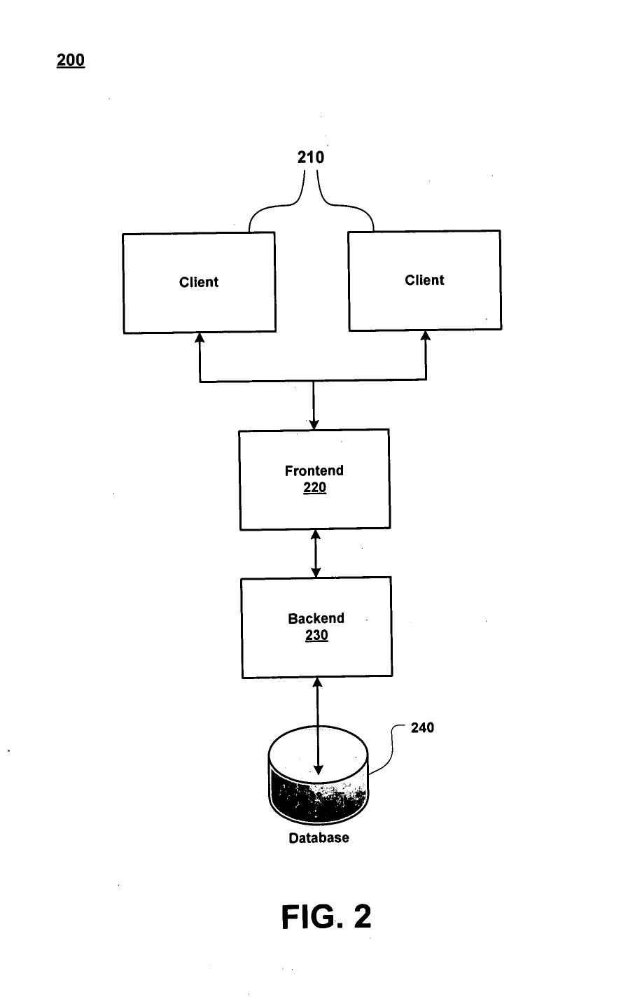

Moreover, computing system environment 100 may be further integrated within a network-based system 200 for accessing a database 240, as shown in the block diagram of FIG. 2. In network-based system 200, clients 210 communicate with a frontend 220. Frontend 220 communicates with the clients 210 and takes any input from the clients 210 and translates it into the appropriate database language for database 240. Frontend 220 then transmits the database commands to backend 230. Backend 230 interacts with the database 240 and performs various operations on database 240 in accordance with the commands received from the frontend 220.

The claimed subject matter is described in terms of these example environments. Description in these terms is provide for convenience only. It is not intended that the invention be limited to application in this example environment. In fact, after reading the following description, it will become apparent to a person skilled in the relevant art how to implement the claimed subject matter in alternative embodiments.

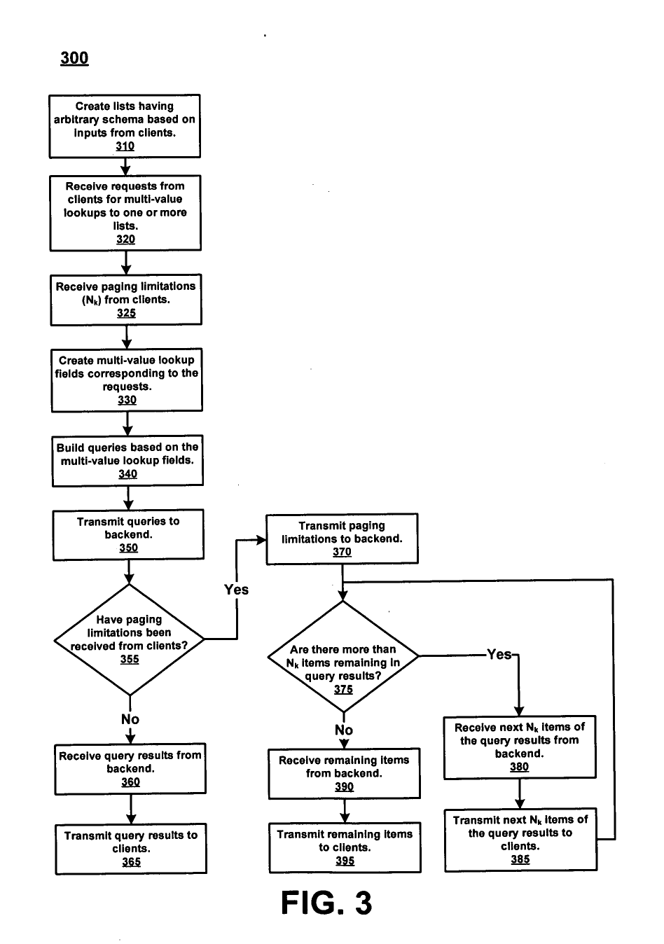

FIG. 3 shows a flowchart of a process 300 for performing multi-valued lookups to lists having arbitrary schema, in accordance with an embodiment. Process 300 may be implemented on the operating environments described above. Process 300 is well-suited to be stored as instructions on a computer-readable medium. In an exemplary embodiment, process 300 operates on a web server. It is appreciated that not all steps of process 300 are necessary for the general goal of process 300 to be achieved. Moreover, it is appreciated that additional steps may also be included in process 300 in accordance with alternative embodiments.

Process 300 begins at step 310, where list having arbitrary schema based on inputs from clients are created. One client, for example, may create lists of potential groceries and area supermarkets, as shown below in Tables 1 and 2 respectively.

TABLE 1
A sample list with arbitrary schema

| Groceries | ID |
|---|---|
| tomato | 1 |
| carrot | 2 |
| potato | 3 |
| basil | 4 |
| onion | 5 |
| beef | 6 |
| chicken | 7 |
| fish | 8 |
| egg | 9 |
| milk | 10 |
| orange juice | 11 |
| soda | 12 |

TABLE 2
Another sample list with arbitrary schema

| SuperMarkets | ID |
|---|---|
| Whole Foods | 1 |
| Safeway | 2 |
| Albertsons | 3 |
| Trader Joe | 4 |
| Larry's Market | 5 |
| Farmer's Market | 6 |

It is appreciated that these lists can be stored in a number of different ways. For example, in a server-based solution, it is desirable to minimize communications and data transfers. In such a case it may be appropriate to store all the lists for a particular client in a single data table, such as Table 3.

TABLE 3

| Produce | SuperMarkets | ID |
|---|---|---|
| tomato | Whole Foods | 1 |
| carrot | Safeway | 2 |
| potato | Albertsons | 3 |
| basil | Trader Joe | 4 |
| onion | Larry's Market | 5 |
| beef | Farmer's Market | 6 |
| chicken | | 7 |
| fish | | 8 |
| egg | | 9 |
| milk | | 10 |
| orange juice | | 11 |
| soda | | 12 |

At step 320, requests are received from clients for multi-valued lookups to one or more lists. For example, a client may wish to create a daily shopping list based on the sample lists in Table 1 and Table 2. For instance, on Monday a user may need to buy beef, carrots, eggs, and milk. Moreover, the user may need to go to Farmer's Market and Whole Foods to get all of these items. Thus, the user requires a multi-value lookup to both lists.

At step 325, paging limitations may also be received from the clients. By transmitting a paging limitation, a user may limit the number of items that are returned to the user per viewable page. For example, if the user sets a paging limitation of two, the first page that the user would see would contain Monday's and Tuesday's shopping lists, the second page would return Wednesday's and Thursday's shopping lists, and so on.

At step 330, multi-value lookup fields corresponding to the clients' requests are created. The multi-value lookup fields may take on a number of formats. In one embodiment, for example, the multi-value lookup fields are contained within a single junction table (described in detail below). Thus, in the example described above, Monday's shopping list comprises four lookups to “Groceries” and two lookups to “Supermarkets”. At step 340, queries are built based on the multi-value lookup fields. The queries are then transmitted to the backend (step 350).

At this point, if paging limitations have not been received from clients (step 355), all of the query results are received from the backend (step 360). The query results returned from the backend may take on a number of forms. For example, a server-optimized solution may take the form of a table, wherein the lookups from one list are contained in one column of the table and the lookups from a second list are contained in another column of the same table. Thus, the number of rows returned in the table is the greatest of the numbers of items returned from each list. Using the above example of Monday's shopping list to illustrate, since four grocery items and two supermarkets are returned, the query result for Monday's shopping list will have four rows, as shown in Table 4.

TABLE 4
Sample Query Results

| MVL Source | | | | |
|---|---|---|---|---|
| Item | Grocery ID | Grocery | Store ID | Store Name |
| Monday | 6 | beef | 6 | Farmer's |
| | | | | Market |
| Monday | 2 | carrot | 1 | Whole Foods |
| Monday | 9 | egg | NULL | NULL |
| Monday | 10 | milk | NULL | NULL |

At step 365, the query results are then transmitted to the clients. It is appreciated that the query results can be transmitted to the clients in many different ways. For example, the results may be transmitted to the clients in a human-readable format, such as HTML. The results may also be transmitted as a spreadsheet file.

If paging limitations have been received from clients (step 355), the paging limitations are then forwarded to the backend (step 370). At step 375, a determination is made as to whether the number of items remaining in the query results for each client is greater than the paging limitations, Nₖ. If so, process 300 proceeds to step 380, where a number of items of the query results equal to the paging limitation (Nₖ) is received from the backend. At step 385, Nₖ items of the query results are then forwarded to the clients. If the number of items remaining in the query results is not greater than the paging limitation, process 300 proceeds to step 390, where the remaining items are received from the backend. The items are then forwarded to the clients (step 395). To illustrate, the item “Monday” in Table 4 above contains four actual rows of query data. If, for example, there was also an item “Tuesday” that contained two rows of query data and the paging limitation is set to two, process 300 would return the six rows of query data corresponding to the items Monday and Tuesday.

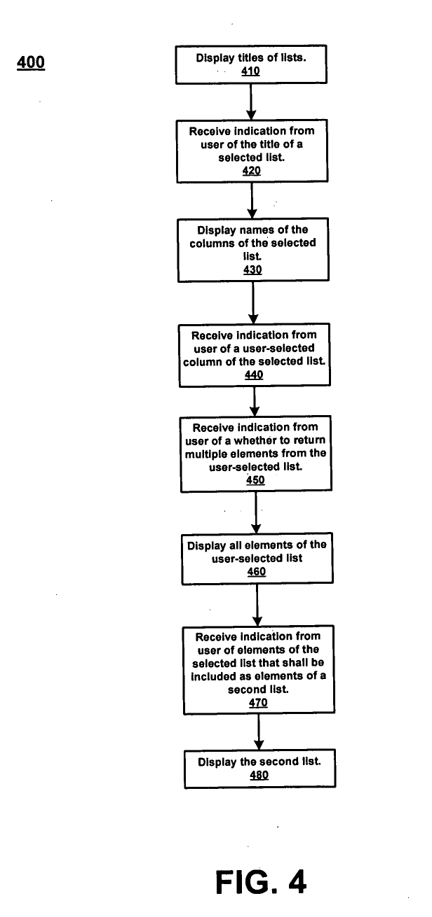

FIG. 4 illustrates a flowchart of a process 400 for displaying on a display device a plurality of first lists and a second list, in accordance with an embodiment. It is appreciated that not all steps of process 400 are necessary for the general goal of process 400 to be achieved. Moreover, it is appreciated that additional steps may also be included in process 400 in accordance with alternative embodiments.

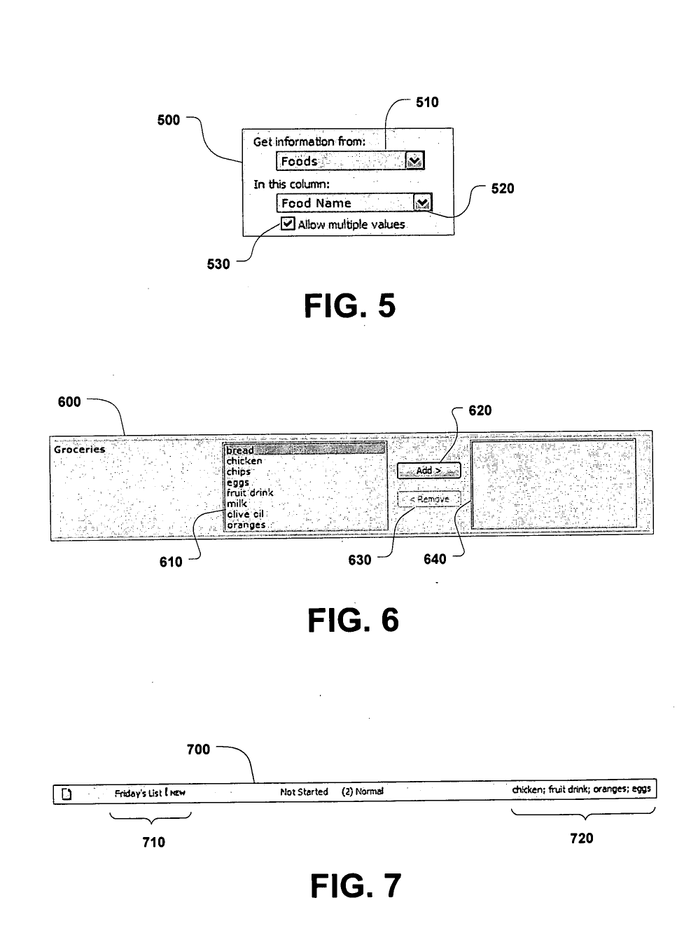

Process 400 begins at step 410, where titles of the first lists are displayed. The titles may be displayed several different ways, such as in a drop down box, a list of hyperlinks, etc. FIG. 5 shows one example of a display 500 for showing the titles of the first lists. In display 500, the titles of the first lists are contained in drop-down list 510.

At step 420, an indication from the user as to the title of a selected list is received. This step may involve activating a hyperlink, making a selection from a drop-down list, etc. For example, in display 500, the “Foods” list has been selected from drop-down list 510.

At step 430, names of the columns of the selected list are displayed. The names may be displayed several different ways, such as in a drop down box, a list of hyperlinks, etc. For example, in display 500, the names of the columns are contained in drop-down list 520.

At step 440, an indication from the user as to a user-selected column of the selected list is received. This step may involve activating a hyperlink, making a selection from a drop-down list, etc. For example, in display 500, the “Food Name” column of the “Foods” list has been selected from drop-down list 520.

At step 450, an indication from the user of whether to return multiple elements from the user-selected list. This step may be achieved several different ways, such as selecting a checkbox, selecting an option in a drop-down menu, etc. For example, in display 500, returning multiple values has been selected by checking checkbox 530.

At step 460, all elements of the user-selected list are displayed. The elements may be displayed several different ways, such as in a scrolling list, a text list, a series of icons, etc. FIG. 6 shows one example of a display 600 for showing the elements of the user-selected list. In display 600, the elements of the user-selected list are contained in scrolling list 610.

At step 470, an indication from the user of elements of the selected list that shall be included as elements of the second list is received. This step may be achieved several different ways, such as selecting elements from a scrolling list, dragging and dropping elements into a window corresponding to the second list, selecting checkboxes associated with the elements, etc. In display 600 for example, groceries are selected by highlighting the names of the desired groceries in scrolling list 610 and then clicking on the Add button 620. The selected items will then appear in scrolling list 640. Items can also be de-selected by highlighting the name of an item in scrolling list 640 and then clicking the Remove button 630. The user may then make an indication that he or she is finished selecting items to go into the second list, such as by clicking a particular button (not shown).

At step 480, the second list is displayed. FIG. 7 shows one example of a display 700 for displaying the second list. Display 700 shows the name of the new list 710 and the elements contained in the list 720. In this example, the user has created a new shopping list for Friday that contains chicken, fruit drink, oranges, and eggs. Although not shown, the list name 710 and element names 720 may be hyperlinks that, when activated, take the user to screen containing detailed information about the item selected.

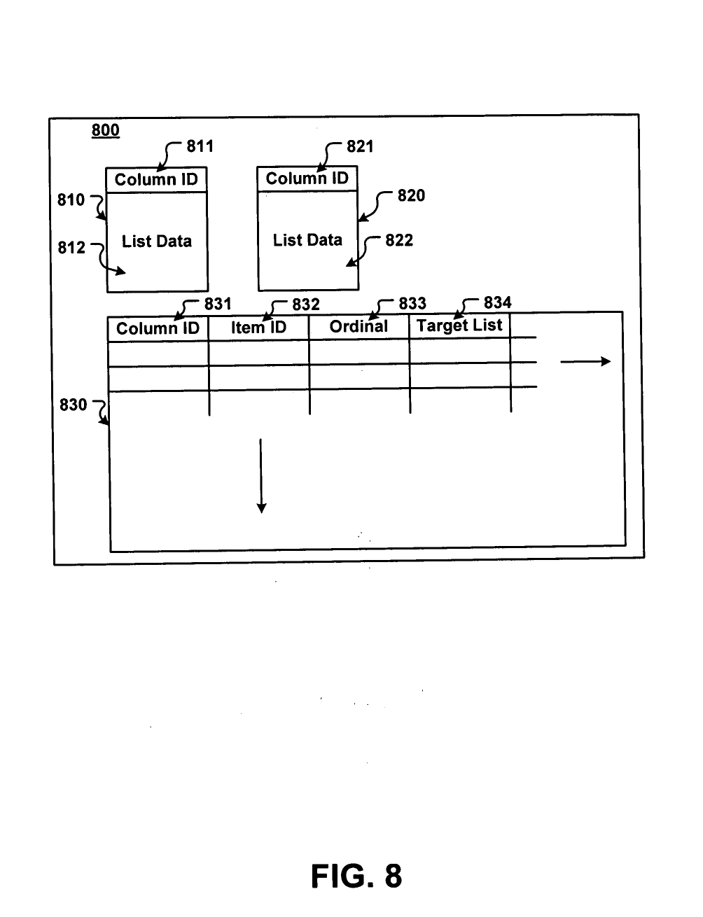

FIG. 8 shows a block diagram of a data structure 800, which is stored on a computer-readable medium, in accordance with an embodiment. The data structure 800 includes a first data field 810 containing data representing a first list 812 having a first schema arbitrarily chosen by a user. The data structure 800 also includes a second data field 820 containing data representing a second list 822 having a second schema arbitrarily chosen by the user. The first and the second data fields may take on various forms, such as arrays, individual items linked by pointers, etc. In one embodiment, the first and the second list are represented as separate columns in a single data table. One example of such a data table is Table 3 above. Moreover, since both the first list 812 and the second list 822 have arbitrary schema, it is possible that a particular item of data (e.g., in first list 812) spans more than one row. The first data field 810 and the second data field 820 also have list identifiers, denoted as column IDs 811 and 821 respectively.

Data structure 800 also includes a junction table 830, which represents a third list comprising multi-value lookups to the first list 812 and the second list 822. Unique to junction table 830 is the fact that it contains multi-value lookups to more than one list. This aspect is critical in a server-based solution, because it ensures that the allocation of server resources is preserved. In one embodiment, junction table 830 includes a Column ID column 831. As previously stated, the first list 812 and the second list 822 have Column IDs 811 and 821 associated with them. Thus, Column ID column 831 of junction table 830 serves to associate data in a row of the junction table 830 with a particular list. In one embodiment, junction table also contains an Item ID column 832. Each item of the first list 812 and the second list 822 has an Item ID associated with in. The Item ID column 832 of junction table 830 servers to associate data in a row of the junction table 830 with a particular source item. Thus, the combination of the Column ID column 831 and the Item ID column 832 allow a row of junction table 830 to be associated with a specific item of a specific list.

In one embodiment, junction table 830 includes a Target List column 834 for designating the target list for the data in a particular row. Target List column 834 allows for junction table 830 to contain multi-value lookups for multiple target lists (e.g., Monday, Tuesday, and Wednesday).

In one embodiment, junction table 830 includes an Item Ordinal column 833. Item Ordinal column 833 is added to junction table 830 to improve efficiency in database queries by avoiding combinational growth. The item ordinal effectively designates a row of a query result in which the respective item should appear. Table 5 illustrates an example of an exemplary junction table, in accordance with an embodiment.

TABLE 5
Sample Junction Table

| | | | Item |
|---|---|---|---|
| MVL Source Item | Column ID | Item ID | Ordinal |
| Monday | 2 | 6 | 0 |
| Monday | 2 | 1 | 1 |
| Monday | 1 | 6 | 0 |
| Monday | 1 | 2 | 1 |
| Monday | 1 | 9 | 2 |
| Monday | 1 | 10 | 3 |
| Tuesday | 2 | 2 | 0 |
| Tuesday | 1 | 4 | 0 |
| Tuesday | 1 | 7 | 1 |
| Wednesday | 2 | 3 | 0 |
| Wednesday | 2 | 4 | 1 |
| Wednesday | 1 | 8 | 0 |
| Wednesday | 1 | 5 | 1 |
| Wednesday | 1 | 11 | 2 |
| Wednesday | 1 | 1 | 3 |

The multi-value lookup (MVL) lists are identified by source items for illustrative purposes. It is appreciated that the MVL lists may be identified by other means, such as by directory name and leaf name for example. For the purposes of Table 5, assume that a Column ID of 1 corresponds to the “Produce” column of Table 3 and a Column ID of 2 corresponds to the “Supermarkets” column. To illustrate, row 0 of a query result for Monday would contain both beef and Farmer's Market. However, since only two results are returned from the Supermarkets list for Monday, row 3 of a query result for Monday would only contain milk. Table 6 illustrates a complete query result based on the sample junction table of Table 5.

TABLE 6
Sample Query Result based on Table 5

| MVL List | | | | |
|---|---|---|---|---|
| Name | Grocery ID | Grocery | Store ID | Store Name |
| Monday | 6 | beef | 6 | Farmer's |
| | | | | Market |
| Monday | 2 | carrot | 1 | Whole Foods |
| Monday | 9 | egg | NULL | NULL |
| Monday | 10 | milk | NULL | NULL |
| Tuesday | 4 | basil | 2 | Safeway |
| Tuesday | 7 | chicken | NULL | NULL |
| Wednesday | 8 | fish | 3 | Albertsons |
| Wednesday | 5 | onion | 4 | Trader Joe |
| Wednesday | 11 | orange juice | NULL | NULL |
| Wednesday | 1 | tomato | NULL | NULL |

A typical database does not involve an item ordinal and would therefore suffer from combinational growth. In the preceding example, the number of rows returned in a typical query would be the product of grocery items found and supermarket items found (e.g., eight rows for Monday, two rows for Tuesday, eight rows for Wednesday, eighteen total rows). Note in Table 6 that only 10 rows of data are required—a substantial savings in terms data transfer requirements.

Thus, embodiments provide technology for performing multi-value lookups to lists having arbitrary schema. The techniques and data structures described herein provide for efficient data storage and transmission. Such technology is ideal for a highly scalable server capable of supporting numerous schemas. Because of the efficiency of the technology described herein, it is possible for a server to support a greater number of users than its maximum number of connections.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for performing multi-valued lookups comprising:
creating a plurality of lists having arbitrary schema based on inputs from a plurality of clients;
receiving requests from the clients for multi-value lookups to at least one of the lists;
creating multi-value lookup fields corresponding to the requests;
building queries based on the multi-value lookup fields;
transmitting the queries to a backend;
receiving query results from the backend; and
transmitting the query results to the clients.

2. The method as recited in claim 1 wherein the method is implemented via a web page.

3. The method as recited in claim 1 wherein the multi-value lookup fields for a particular client are contained within a single junction table.

4. The method as recited in claim 1 wherein the lists for a particular client are stored within a single data table.

5. The method as recited in claim 1 further comprising:
receiving paging limitations (Nₖ) from the clients;
transmitting the paging limitations to the backend; and
if the number of items in the query results is greater than Nₖ, receiving Nₖ items at a time from the backend.

6. The method as recited in claim 1 wherein the query results are transmitted to the clients in a human readable format.

7. The method as recited in claim 6 wherein the human readable format is HTML.

8. The method as recited in claim 1 wherein each list comprises at least one column, wherein the query results comprise a number of rows, and wherein the number of rows equals the greatest of the numbers of items returned from each of the columns.

9. A method in a computer system for displaying on a display device a plurality of first lists and a second list, wherein each of the plurality of first lists has at least one corresponding element, the method comprising:
displaying on the display device titles identifying ones of the plurality of first lists, wherein the first lists have arbitrary schema;
receiving an indication from a user of the title of a user-selected list from the plurality of first lists;
displaying on the display device all elements of the user-selected list;
receiving an indication from the user of user-selected elements from the user-selected list that shall be included as elements of the second list; and
displaying on the display device the elements of the second list.

10. The method as recited in claim 9 wherein the titles are displayed in a drop-down list.

11. The method as recited in claim 9 further comprising:
displaying on the display device column names corresponding to columns of the user-selected list;
receiving an indication from the user of a user-selected column;

12. The method as recited in claim 9 further comprising:
receiving an indication from the user of whether to return multiple elements from the user-selected list.

13. The method as recited in claim 9 wherein the method is implemented via a web interface.

14. A computer-readable medium having stored thereon a data structure, comprising:
a first data field containing data representing a first list having a first schema arbitrarily chosen by a user;
a second data field containing data representing a second list having a second schema arbitrarily chosen by the user; and
a junction table representing a third list comprising multi-value lookups to the first list and the second list.

15. The computer-readable medium as recited in claim 14 wherein the first data field is a first column in a data table and the second data field is a second column in the data table.

16. The computer-readable medium as recited in claim 15 wherein an item of data spans more than one row of the data table.

17. The computer-readable medium as recited in claim 15 wherein the first column and the second column have unique column IDs and the junction table comprises a third column for associating data in a row of the junction table with a particular list by means of the column IDs.

18. The computer-readable medium as recited in claim 14 wherein the junction table comprises a target list column for designating a target list for the data of a particular row.

19. The computer-readable medium as recited in claim 14 wherein the elements of the first list and the second list are associated with item IDs, and wherein the junction table comprises an item ID column for designating a source element for the data of a particular row.

20. The computer-readable medium as recited in claim 14 wherein the junction table comprises an item ordinal for designating a position in a vector for the data of a particular row.
